(19) United States
(12) Patent Application Publication
(10) Pub. No.: US 2014/0207834 A1
(43) Pub. Date: Jul. 24, 2014

(54) SYSTEMS AND METHODS FOR SCALABLE STORAGE NAME SERVER INFRASTRUCTURE

(71) Applicant: DELL PRODUCTS L.P., Round Rock, TX (US)

(72) Inventors: Jacob Cherian, Austin, TX (US); Gaurav Chawla, Austin, TX (US)

(73) Assignee: Dell Products L.P., Round Rock, TX (US)

(21) Appl. No.: 13/746,893

(22) Filed: Jan. 22, 2013

(51) Int. Cl. G06F 17/30

(52) U.S. Cl. CPC G06F 17/30283
USPC 707/827

(57) ABSTRACT

In accordance with embodiments of the present disclosure, a method may include extracting identities of one or more hosts from a storage resource-to-host mapping database associated with a storage resource. The method may also include, for each of the one or more hosts: computing a discovery domain unique identifier based on the host unique identifier, determining if the discovery domain unique identifier is present in a discovery domain database associated with the storage resource, and adding a storage resource unique identifier of the storage resource to an entry of the discovery domain database associated with the storage resource.

### TECHNICAL FIELD

The present disclosure relates in general to information handling systems, and more particularly to scalability of storage name servers in storage systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Dedicated storage solutions are commonplace in the market, particularly in the implementation of data centers. Such storage solutions may be in the form of network-based solutions which are often implemented as or part of a storage area network (SAN) employing Internet Small Computer System Interface (iSCSI), Fibre Channel, or other suitable communications standards. However, management of large numbers of storage devices, particularly iSCSI SANs is often challenging. Traditionally, such SANs deploy a name server (e.g., an Internet Storage Name Service or iSNS) configured to discover storage devices and partition a storage network into discovery domains that allow control of which information handling systems and which storage resources are allowed to discover each other. However, use of a name server introduces management complexity as it requires management of the name server in addition to the individual storage resources, and presents challenges to scalability and high availability of the name server. This problem is further complication by storage arrays that employ a scale-out models, which aggregate multiple storage resources into a single logical storage array that presents storage resources in the form of logical units (LUNs), volumes, etc. to a host.

### SUMMARY

In accordance with the teachings of the present disclosure, the disadvantages and problems associated with scalability storage systems have been reduced or eliminated.

In accordance with embodiments of the present disclosure, a method may include extracting identities of one or more hosts from a storage resource-to-host mapping database associated with a storage resource. The method may also include, for each of the one or more hosts: computing a discovery domain unique identifier based on the host unique identifier, determining if the discovery domain unique identifier is present in a discovery domain database associated with the storage resource, and adding a storage resource unique identifier of the storage resource to an entry of the discovery domain database associated with the storage resource.

In accordance with these and other embodiments of the present disclosure, a method may include receiving an operation request at a first storage resource of a plurality of storage resources from a host having a host unique identifier. The method may also include computing a storage resource unique identifier associated with the operation request. The method may further include forwarding the operation request to a second storage resource having the storage resource unique identifier for processing by the second storage resource.

In accordance with these and other embodiments of the present disclosure, a method may include directing a query from a host to a first storage resource of a plurality of storage resources participating in a federated name server with functionality distributed across the plurality of storage resources. The method may also include computing a storage resource unique identifier associated with the host. The method may further include forwarding the query to a second storage resource having the storage resource unique identifier.

Technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example deployment of a storage system, in accordance with certain embodiments of the present disclosure;

FIG. 2 illustrates a block diagram of an example storage resource for use in the storage system depicted in FIG. 1, in accordance with certain embodiments of the present disclosure;

FIG. 3 illustrates an example discovery domain database for use in the storage resource depicted in FIG. 2;

FIG. 4 illustrates a flow chart of an example method for generating storage name server discovery domain information, in accordance with the present disclosure;

FIG. 5 illustrates a flow chart of an example method for mapping a storage resource to a new host introduced to a storage system, in accordance with the present disclosure; and

FIG. 6 illustrates a flow chart of an example method for discovery by a host of its associated storage resources in a storage system, in accordance with the present disclosure.

### DETAILED DESCRIPTION

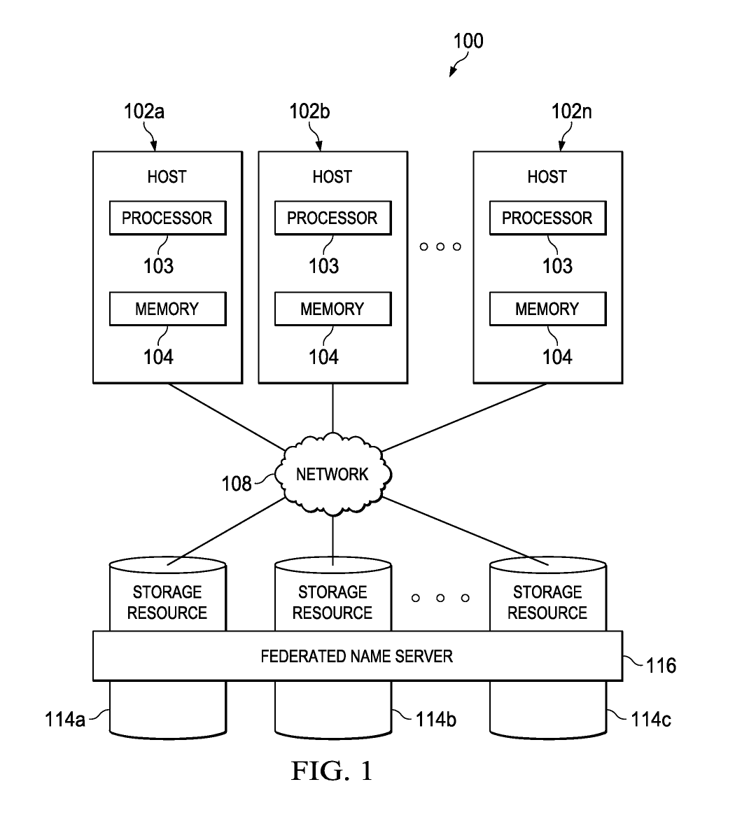

Preferred embodiments and their advantages are best understood by reference to FIGS. 1-6, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more busses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, BIOSs, busses, memories, I/O devices and/or interfaces, storage resources, network interfaces, motherboards, and/or any other components and/or elements of an information handling system.

An information handling system may include or may be coupled to an array of physical storage resources. The array of physical storage resources may include a plurality of physical storage resources, and may be operable to perform one or more input and/or output storage operations, and/or may be structured to provide redundancy. In operation, one or more physical storage resources disposed in an array of physical storage resources may appear to an operating system as a single logical storage array.

In certain embodiments, an array of physical storage resources may be implemented as a Redundant Array of Independent Disks (also referred to as a Redundant Array of Inexpensive Disks or a RAID). RAID implementations may employ a number of techniques to provide for redundancy, including striping, mirroring, and/or parity generation/checking. As known in the art, RAIDs may be implemented according to numerous RAID levels, including without limitation, standard RAID levels (e.g., RAID 0, RAID 1, RAID 3, RAID 4, RAID 5, and RAID 6), nested RAID levels (e.g., RAID 01, RAID 03, RAID 10, RAID 30, RAID 50, RAID 51, RAID 53, RAID 60, RAID 100), non-standard RAID levels, or others.

FIG. 1 illustrates a block diagram of an example storage system 100, in accordance with certain embodiments of the present disclosure. As depicted in FIG. 1, system 100 may include one or more hosts 102 and a storage array of storage resources 114 communicatively coupled to each host 102 via a network 108.

A host 102 may comprise an information handling system. A host 102 may generally be operable to receive data from and/or communicate data to one or more storage resources 114 via network 108. In certain embodiments, host 102 may be a server. In another embodiment, host 102 may be a dedicated storage system such as, for example, a network attached storage (NAS) system responsible for operating on the data in a storage array (e.g., a logical storage array 110 comprising storage resources 114) and sending and receiving data from hosts coupled to the storage system. As depicted in FIG. 1, a host 102 may include a processor 103 and a memory 104 communicatively coupled to processor 103.

A processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, a processor 103 may interpret and/or execute program instructions and/or process data stored in an associated memory 104, stored in logical storage array 110, and/or another component of a host 102 and/or system 100.

A memory 104 may be communicatively coupled to an associated processor 103 and may include any system, device, or apparatus configured to retain program instructions and/or data for a period of time (e.g., computer-readable media). A memory 104 may include RAM, EEPROM, a PCMCIA card, flash memory, magnetic storage, opto-magnetic storage, or any suitable selection and/or array of volatile or non-volatile memory that retains data after power to a host 102 is turned off.

In addition to a processor 103 and a memory 104, a host 102 may include one or more other information handling resources. An information handling resource may include any component system, device or apparatus of an information handling system, including without limitation a processor (e.g., processor 103), bus, memory (e.g., memory 104), input-output device and/or interface, storage resource (e.g., hard disk drives), network interface, electro-mechanical device (e.g., fan), display, power supply, and/or any portion thereof. An information handling resource may comprise any suitable package or form factor, including without limitation an integrated circuit package or a printed circuit board having mounted thereon one or more integrated circuits.

Network 108 may be a network and/or fabric configured to communicatively couple hosts 102 to each other and to logical storage array 110. In certain embodiments, network 108 may include a communication infrastructure, which provides physical connections, and a management layer, which organizes the physical connections of hosts 102, member storage arrays 112, and other devices coupled to network 108. Network 108 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 108 may transmit data using any storage and/or communication protocol, including without limitation, Fibre Channel, Fibre Channel over Ethernet (FCoE), Small Computer System Interface (SCSI), Internet SCSI (iSCSI), Frame Relay, Ethernet Asynchronous Transfer Mode (ATM), Internet protocol (IP), or other packet-based protocol, and/or any combination thereof. Network 108 and its various components may be implemented using hardware, software, or any combination thereof.

Logical storage array 110 may comprise a plurality of member storage arrays 112 configured to logically appear to each host 102 as a single logical storage array. Each member storage array 112 may comprise part of a RAID and/or other suitable redundant storage array, and itself may include a plurality of member storage resources 114.

Storage resources 114 may include hard disk drives, magnetic tape libraries, optical disk drives, magneto-optical disk drives, compact disk drives, compact disk arrays, disk array controllers, and/or any computer-readable medium operable to store data. In some embodiments, storage resources 114 may form all or part of a redundant storage array. In such embodiments, storage resources 114 participating in the redundant storage array may appear to an operating system executing on host 102 as a single logical storage unit or virtual resource. Thus, host 102 may “see” a logical unit instead of seeing each individual physical storage resource 114. Although FIG. 1 depicts storage resources 114 as components of system 100 separate from host 102, in some embodiments, one or more storage resources 114 may be integral to host 102. Storage resources 114 may be housed in one or more storage enclosures configured to hold and power storage resources 114. As shown in FIG. 1, a federated name server 116 may be implemented across a plurality of storage resources 114.

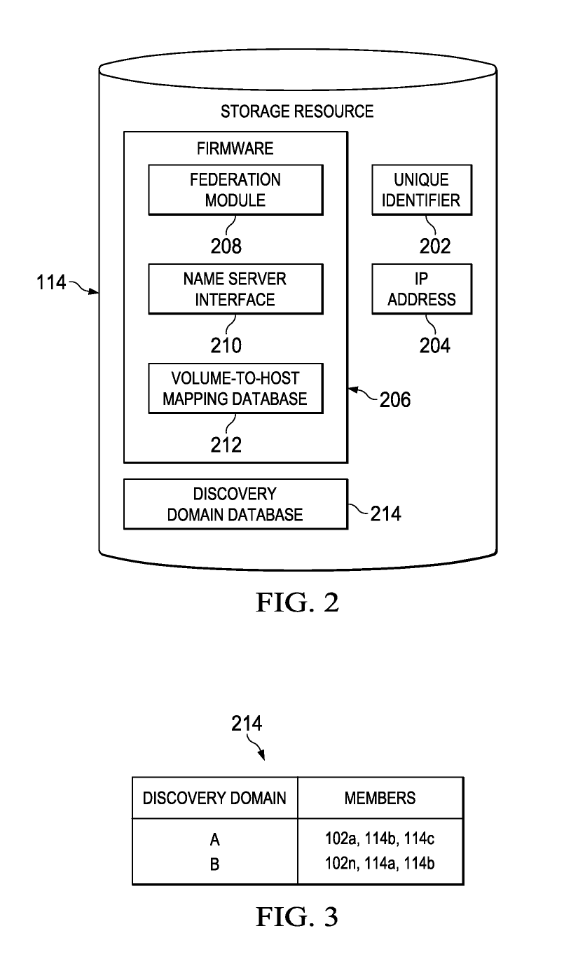

Federated name server 116 may be any system distributed among a plurality of storage resources 114 and configured to provide storage name service and/or other functionality typically performed by a standalone name server independent from storage resources 114. An example implementation of a federated name server 116 is set forth in greater detail in the discussion of FIGS. 2 and 3, below.

FIG. 2 illustrates a block diagram of an example storage resource 114 for use in the storage system 100 depicted in FIG. 1, in accordance with certain embodiments of the present disclosure. In addition to computer-readable media for storing data and instructions, a storage resource 114 may also include a unique identifier 202, an Internet Protocol (IP) address 204, firmware 206, and a discovery domain database 214.

Unique identifier 202 may be any alphabetical, numeric, or alphanumeric string for uniquely identifying a storage resource 114 with respect to other storage resources 114 in storage system 100. Similar, IP address 204 may comprise an IP address local to its respective storage resource 114 for facilitating communication over network 108 using Internet Protocol.

Firmware 206 may comprise instructions executable by storage resource 114 (e.g., by an application specific integrated circuit, not expressly shown, of storage resource 114) and/or data embodied in computer-readable media dedicated to storing firmware 206. As shown in FIG. 2, firmware 206 may comprise a federation module 208, a nameserver interface 210, and a storage resource-to-host mapping database 212.

Federation module 208 may comprise an executable set of instructions configured to distribute discovery domain information for individual hosts 102 across storage resources 114 based on unique identifiers of the individual hosts 102 and process or forward requests from individual hosts 102 in order to respond to such requests to provide relevant discovery domain information responsive to the requests. To further illustrate, based on a unique identifier x for a host 102 (e.g., an iSCSI Qualified Name), federation module 208 may compute a function z=G(x) where z is a unique identifier (e.g., alphabetical, numeric, or alphanumeric) for a given discovery domain in a discovery domain database 214 of a storage resource 114. The function G(x) may be a modulo hash function, assuring that for any value of x, a unique value of z will be calculated.

Further, federation module 208 may, for a subset of m storage resources 114 hosting federated name server 116, compute a function y=F(z) where y is a storage resource unique identifier 202 that belongs to the set [1, m]. The unique identifier 202 value y may determine from among the m storage resources 114 participating in federated name server 116 the storage resource 114 that will store discovery domain information for the host 102 with unique identifier x. The function F(y) may be a modulo function based on the value m, assuring approximately equal distribution of domain discovery information among the various storage resources 114, provided that values of x and z are sufficiently random.

Name server interface 210 may comprise an executable set of instructions configured to enable a storage resource to process name service requests and provide an interface compliant with relevant standards (e.g., iSCSI Storage Name Service or iSNS) to information handling resources 102 such that federated name server 116 may appear as a standalone name server to hosts 102.

Storage resource-to-host mapping database 212 may, as is known in the relevant art, include information regarding access control information between hosts 102 and storage resources 114, including mappings between individual hosts 102 and individual storage resources 114 available to each individual host 102.

A discovery domain database 214 may include any table, map, list, or other suitable data structure setting forth one or more discovery domains and the various hosts 102 and storage resources 114 which are members of the discovery domain. FIG. 3 illustrates an example discovery domain database 214. For clarity of exposition, database entries for discovery domains are given generic identifiers (e.g., A and B) rather than their unique identifiers calculated by z=G(x). Similarly, for clarity of exposition, database entries for hosts 102 and storage resources 114 are given by reference numerals set forth in FIG. 1, rather than unique identifiers or IP addresses, as would likely be the case in actual implementation.

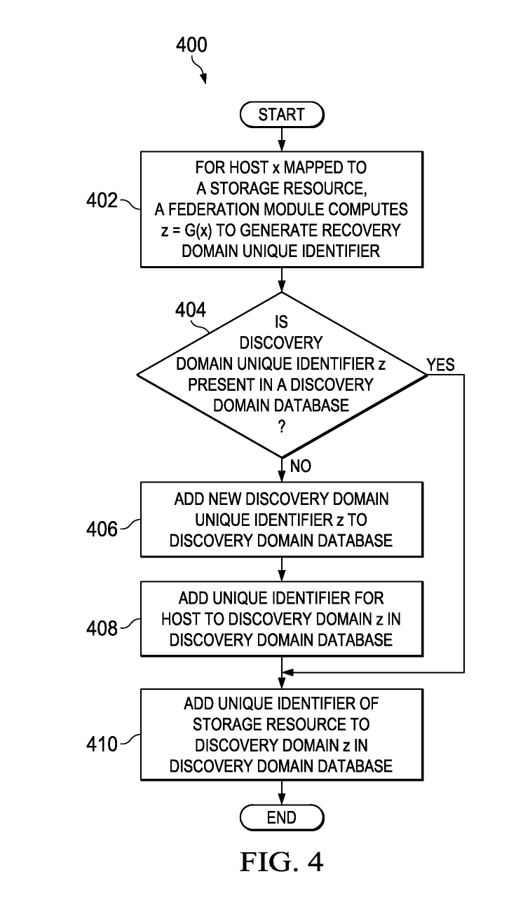

FIG. 4 illustrates a flow chart of an example method 400 for generating storage name server discovery domain information, in accordance with the present disclosure. According to one embodiment, method 400 may begin at step 402. As noted above, teachings of the present disclosure may be implemented in a variety of configurations of system 100. As such, the preferred initialization point for method 400 and the order of the steps comprising method 400 may depend on the implementation chosen.

A storage resource-to-host mapping database (e.g., storage resource-to-host mapping database 212) may be used as an input to method 400, such that method 400 will be applied to each host 102 set forth in a storage resource-to-host mapping database.

At step 402, for a particular host with unique identifier x (e.g., a host 102) mapped to a storage resource, a federation module (e.g., federation module 208) may compute function z=G(x) to generate a discovery domain unique identifier z.

At step 404, the federation module may determine if the unique domain discovery identifier z is present in a domain discovery database (e.g., a discovery domain database 214) of a storage resource 114. If the unique domain discovery identifier z is present, method 400 may proceed to step 406. Otherwise, method 400 may proceed to step 410.

At step 406, in response to determining that the unique domain discovery identifier z is not present in a discovery domain database, the federation module may add a new discovery domain unique identifier z to the discovery domain database.

At step 408, the federation module may add the unique identifier x for the host to discovery domain z in the discovery domain database.

At step 410, the federation module may add the unique identifier of the storage resource (e.g., a unique identifier 202 or IP address 204) to discovery domain z in the discovery domain database. After completion of step 410, method 400 may end.

Although FIG. 4 discloses a particular number of steps to be taken with respect to method 400, method 400 may be executed with greater or lesser steps than those depicted in FIG. 4. In addition, although FIG. 4 discloses a certain order of steps to be taken with respect to method 400, the steps comprising method 400 may be completed in any suitable order.

Method 400 may be implemented using system 100 or any other system operable to implement method 400. In certain embodiments, method 400 may be implemented partially or fully in software and/or firmware embodied in computer-readable media.

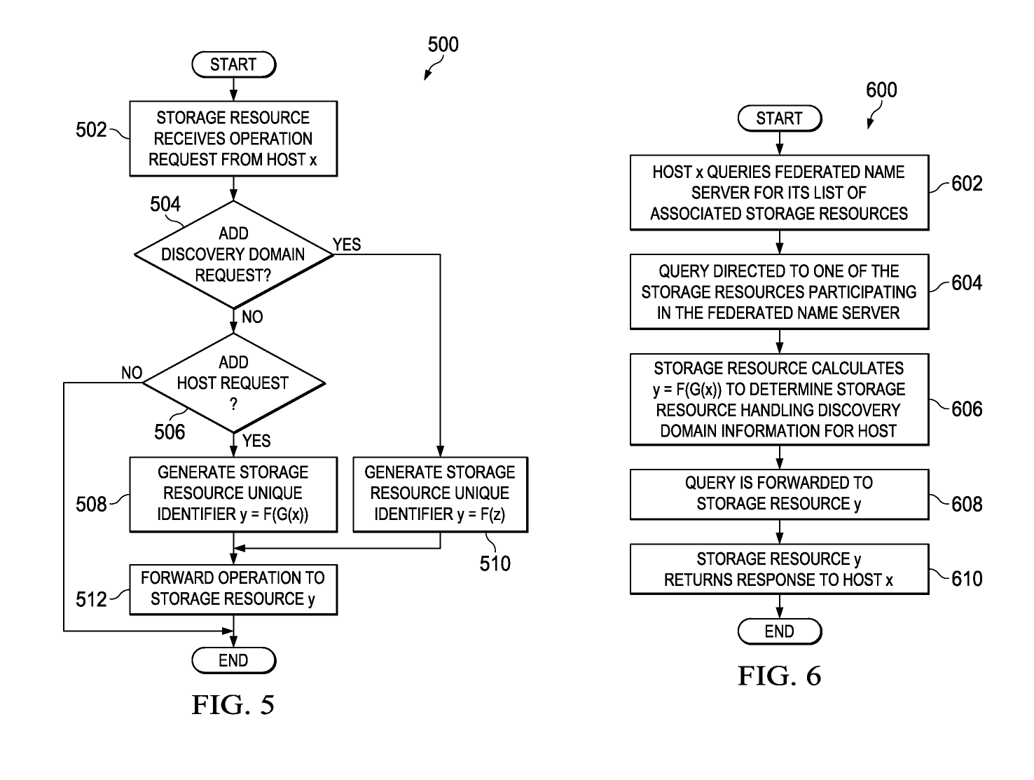

FIG. 5 illustrates a flow chart of an example method 500 for mapping a storage resource to a new host introduced to a storage system, in accordance with the present disclosure. According to one embodiment, method 500 may begin at step 502. As noted above, teachings of the present disclosure may be implemented in a variety of configurations of system 100. As such, the preferred initialization point for method 500 and the order of the steps comprising method 500 may depend on the implementation chosen.

At step 502, a storage resource (e.g., a storage resource 114) may receive an operation request (e.g., an operation to add a discovery domain or add an host to discovery domain information) from an host (e.g., host 102) with a unique identifier x. In some embodiments, storage resources of a storage system may be configured to load balance such operation requests (e.g., by randomly communicating requests to a particular storage resource or intelligently balancing the load so that the operation request processing of storage resources remains approximately equal). Accordingly, the storage resource receiving the request may not necessarily be the storage resource storing discovery domain information for the requesting host.

At step 504, a federation module (e.g., federation module 208) may determine if the request is a request to add a discovery domain with unique identifier z. If the request is a request to add a discovery domain, method 500 may proceed to step 510. Otherwise, method 500 may proceed to step 506.

At step 506, the federation module may determine if the request is a request to add a host to the storage system. If the request is a request to add a host to the storage system, method 500 may proceed to step 508. Otherwise, method 500 may end.

At step 508, in response to a determination that the request is a request to add a host to the storage system, the federation module may compute function y=F(G(x)) to generate a storage resource unique identifier y based on the host unique identifier x. After completion of step 508, method 500 may proceed to step 512.

At step 510, in response to a determination that the request is a request to add a discovery domain, the federation module may compute function y=F(z) to generate a storage resource unique identifier y based on the discovery domain unique identifier z. After completion of step 508, method 500 may proceed to step 512.

At step 512, the storage resource 114 initially receiving the operation request may forward the request to the storage resource with unique identifier y, where the request may be processed (e.g., the storage resource with unique identifier y may add the new discovery domain or new host to its respective discovery domain database).

Although FIG. 5 discloses a particular number of steps to be taken with respect to method 500, method 500 may be executed with greater or lesser steps than those depicted in FIG. 5. In addition, although FIG. 5 discloses a certain order of steps to be taken with respect to method 500, the steps comprising method 500 may be completed in any suitable order.

Method 500 may be implemented using system 100 or any other system operable to implement method 500. In certain embodiments, method 500 may be implemented partially or fully in software and/or firmware embodied in computer-readable media.

FIG. 6 illustrates a flow chart of an example method 600 for discovery by a host of its associated storage resources in a storage system, in accordance with the present disclosure. According to one embodiment, method 600 may begin at step 602. As noted above, teachings of the present disclosure may be implemented in a variety of configurations of system 100. As such, the preferred initialization point for method 600 and the order of the steps comprising method 600 may depend on the implementation chosen.

At step 602, a host (e.g., a host 102) with a unique identifier x may query a federated name server (e.g., federated name server 116) for a list of its associated storage resources (e.g., the storage resources 114 within the same discovery domain as the host).

At step 604, the query may be directed to a particular one of the storage resources participating in the federated name server. For example, in some embodiments, the federated name server may have a virtual IP address by which hosts may access it. Incoming requests to the federated name server may be load balanced across the storage devices participating in the federated name server. For example, a name server interface (e.g., a name server interface 210) of a participating storage resource may receive a request and intelligently route the request so that request processing of the various storage resources is approximately equal. As a specific example, using Address Resolution Protocol (ARP), the federated name server, acting through a name server interface of a participating storage resource, may respond to the host's ARP request with an identifier (e.g., a local IP address 204, a Media Access Control address, etc.) of a suitable storage resource for processing the request and the query may be directed to such storage resource.

At step 606, the federation module of the storage resource to which the query has been directed may compute function y=F(G(x)) to generate a storage resource unique identifier y based on the host unique identifier x. At step 608, the query may be forwarded to the storage resource with unique identifier y.

At step 610, the storage resource with unique identifier y may return a response to the query. The response may include identities of storage resources in the same discovery domain of the information handling resource, as set forth in the discovery domain database of the storage resource with unique identifier y. After completion of step 610, method 600 may end.

Although FIG. 6 discloses a particular number of steps to be taken with respect to method 600, method 600 may be executed with greater or lesser steps than those depicted in FIG. 6. In addition, although FIG. 6 discloses a certain order of steps to be taken with respect to method 600, the steps comprising method 600 may be completed in any suitable order.

Method 600 may be implemented using system 100 or any other system operable to implement method 600. In certain embodiments, method 600 may be implemented partially or fully in software and/or firmware embodied in computer-readable media.

Although the present disclosure has been described in detail, it should be understood that various changes, substitutions, and alterations can be made hereto without departing from the spirit and the scope of the disclosure as defined by the appended claims.

What is claimed is:

1. A method comprising:
extracting identities of one or more hosts from a storage resource-to-host mapping database associated with a storage resource; and
for each of the one or more hosts:
computing a discovery domain unique identifier based on the host unique identifier;
determining if the discovery domain unique identifier is present in a discovery domain database associated with the storage resource; and
adding a storage resource unique identifier of the storage resource to an entry of the discovery domain database associated with the storage resource.

2. The method of claim 1, further comprising, for each of the one or more hosts, in response to determining that the discovery domain unique identifier is not present in a discovery domain database associated with the storage resource:
adding the entry for the discovery domain unique identifier to the discovery domain database associated with the storage resource; and
adding the host unique identifier to the entry of the discovery domain database associated with the storage resource.

3. The method of claim 1, wherein the host unique identifier for each of the one or more hosts is an Internet Small Computer System Interface Qualified Name of the host.

4. The method of claim 1, wherein computing the discovery domain unique identifier for each of the one or more hosts comprises computing a modulo hash function based on the host unique identifier.

5. A method comprising:
receiving an operation request at a first storage resource of a plurality of storage resources from a host having a host unique identifier;
computing a storage resource unique identifier associated with the operation request; and
forwarding the operation request to a second storage resource having the storage resource unique identifier for processing by the second storage resource.

6. The method of claim 5, wherein computing the storage resource unique identifier comprises computing the storage resource unique identifier based on the host unique identifier.

7. The method of claim 6, wherein computing the storage resource unique identifier based on the host unique identifier comprises:
computing a discovery domain unique identifier based on the host unique identifier; and
computing the storage resource unique identifier based on the discovery domain unique identifier.

8. The method of claim 7, wherein computing the discovery domain unique identifier based on the host unique identifier comprises computing a modulo hash function based on the host unique identifier.

9. The method of claim 7, wherein computing the storage resource unique identifier based on the discovery domain unique identifier comprises computing a hash function based on the discovery domain unique identifier.

10. The method of claim 6, wherein computing the storage resource unique identifier based on the host unique identifier occurs in response to a determination that the operation request is a request to add an host unique identifier to a discovery domain database.

11. The method of claim 5, further comprising determining whether the operation request is a request to add a discovery domain unique identifier to a discovery domain database, wherein computing the storage resource unique identifier comprises computing the storage resource unique identifier based on the discovery domain unique identifier.

12. The method of claim 11, wherein computing the storage resource unique identifier based on the discovery domain unique identifier comprises computing a hash function based on the discovery domain unique identifier.

13. The method of claim 5, wherein the host unique identifier for each of the one or more hosts is an Internet Small Computer System Interface Qualified Name of the host.

14. A method comprising:
directing a query from an host to a first storage resource of a plurality of storage resources participating in a federated name server with functionality distributed across the plurality of storage resources;
computing a storage resource unique identifier associated with the host; and
forwarding the query to a second storage resource having the storage resource unique identifier.

15. The method of claim 14, further comprising returning, by the second storage resource, a response to the query.

16. The method of claim 14, wherein computing the storage resource unique identifier comprises computing the storage resource unique identifier based on an host unique identifier of the host.

17. The method of claim 16, wherein computing the storage resource unique identifier based on the host unique identifier comprises:
computing a discovery domain unique identifier based on the host unique identifier; and
computing the storage resource unique identifier based on the discovery domain unique identifier.

18. The method of claim 17, wherein computing the discovery domain unique identifier based on the host unique identifier comprises computing a modulo hash function based on the host unique identifier.

19. The method of claim 14, wherein the query comprises a query by the host for identities of one or more storage resources of a discovery domain of which the host is a member.

20. The method of claim 14, wherein the federated name server is an Internet Small Computer System Interface Storage Name Server.
